(19) United States
(12) Patent Application Publication
(10) Pub. No.: US 2020/0075927 A1
(43) Pub. Date: Mar. 5, 2020

(54) METHOD FOR MANUFACTURING ADSORPTION ELECTRODE AND ADSORPTION ELECTRODE MANUFACTURED USING THE SAME

(71) Applicant: Seoul National University R&DB Foundation, Seoul (KR)

(72) Inventors: Jeyong YOON, Seoul (KR); Jaehan LEE, Seoul (KR); Sungpil HONG, Seoul (KR); Seoni KIM, Seoul (KR); Jiho LEE, Seoul (KR); Hansun YOON, Seoul (KR)

(73) Assignee: Seoul National University R&DB Foundation, Seoul (KR)

(21) Appl. No.: 16/219,957

(22) Filed: Dec. 14, 2018

(30) Foreign Application Priority Data
Sep. 4, 2018 (KR) 10-2018-0105428

(51) Int. Cl. H01M 4/04; H01M 4/36; H01M 4/485

(52) U.S. Cl. CPC H01M 4/049; H01M 2004/021; H01M 4/485; H01M 4/366

(57) ABSTRACT

Disclosed is a method for manufacturing an absorption electrode, and an absorption electrode manufactured using the same, more particularly a method for manufacturing an absorption electrode, and an absorption electrode manufactured using the same, including producing a reduced graphene oxide, producing a composite containing the reduced graphene oxide, and a layered double hydroxide, and producing the absorption electrode containing the composite.

### CROSS-REFERENCE TO RELATED APPLICATIONS

The present application claims the benefit of Korean Patent Application No. 10-2018-0105428 filed on Sep. 4, 2018, in the Korean Intellectual Property Office, the entire contents of which are hereby incorporated by reference.

### BACKGROUND

Embodiments of the inventive concepts described herein relate to a method for manufacturing an absorption electrode, and to an absorption electrode manufactured using the same, and more particularly, relate to a method for manufacturing an absorption electrode capable of selectively absorbing phosphorus or pentavalent arsenic, and having excellent recycling capacity, and to an absorption electrode manufactured using the same.

When a concentration of phosphorus in water is excessively high, resulting in algal bloom. The algal bloom is a very serious environmental pollutant that disturbs aquatic ecosystems. Main reasons for increasing the concentration of the phosphorus in water are various kinds of domestic waste water, and livestock waste water. As long as human life is maintained, excessive generation of the phosphorus may not be avoided. Conventional techniques for removing the phosphorus are biological, and chemical removal methods, and have a disadvantage of generating excessive amounts of chemical sludge. On the other hand, an absorption technology is considered to be an eco-friendly technology that additional sludge does not generated. However, because of high cost of recycling an absorbent, and need for excess chemicals in recycling, the adsorption technology is still not free from a disadvantage that producing environmental pollutant. In addition, the absorption process has a disadvantage that is slower than conventional phosphorus treatment processes.

As a solution to this problem, it is required to develop a technique for efficiently removing the phosphorus without causing the environmental problem. Further, in order to obtain a more effective absorption technique, the phosphorus should be selectively removed.

Patent Document 1: Korean Patent No. 1330570

Patent Document 2: Korean Patent Publication No. 2003-0036825

### SUMMARY

Embodiments of the inventive concept provide a method for manufacturing an absorption electrode, and an absorption electrode manufactured using the same may efficiently remove contaminants such as phosphorus, or pentavalent arsenic from water used as drinking water, and the like, and may recycle the used absorption electrode quickly and environmentally.

Embodiments of the inventive concept provide a method for manufacturing an absorption electrode, and an absorption electrode manufactured using the same capable of absorbing a trace amount of phosphorus or pentavalent arsenic dissolved in water, and of having a high absorption efficiency based on a selectivity.

According to an exemplary embodiment of the inventive concept, a method for manufacturing an absorption electrode includes producing a reduced graphene oxide, producing a composite containing the reduced graphene oxide, and a layered double hydroxide, and producing an absorption electrode containing the composite.

According to an exemplary embodiment of the inventive concept, the producing of the absorption electrode includes mixing the composite, a conductor, and a binder to produce the absorption electrode.

According to an exemplary embodiment of the inventive concept, the producing of the absorption electrode includes mixing the composite, the conductor, and the binder at a ratio of 10:1:1 to 5:1:1.

According to an exemplary embodiment of the inventive concept, the producing of the reduced graphene oxide includes adding a reducing agent to graphene oxide solution to reduce the graphene oxide, and wherein the reducing agent may be selected from a group consisting of hydrazine solution, sodium borohydride, ascorbic acid, phenylhydrazine iodide, and a mixture thereof.

According to an exemplary embodiment of the inventive concept, in producing the composite, the layered double hydroxide may contain a divalent metal and a trivalent metal, and wherein the divalent metal may be at least one selected from a group consisting Zn²⁺, Mn²⁺, Ni²⁺, Co²⁺, Fe²⁺, Cu²⁺, Sn²⁺, Ba²⁺, Ca²⁺, and Mg²⁺, wherein the trivalent metal may be at least one selected from a group consisting of Al³⁺, Cr³⁺, Fe³⁺, Co³⁺, Mn³⁺, Ni³⁺, Ce³⁺, and Ga³⁺.

According to an exemplary embodiment of the inventive concept, the producing of the composite includes adding the reduced graphene oxide to a solution containing the divalent metal and trivalent metal dispersed therein to produce a mixture, and hydrothermally-synthesizing the mixture to obtain the composite containing the reduced graphene oxide and the layered double hydroxide.

### BRIEF DESCRIPTION OF THE FIGURES

The above and other objects and features will become apparent from the following description with reference to the following figures, wherein like reference numerals refer to like parts throughout the various figures unless otherwise specified.

FIG. 1 is a flow chart schematically showing a manufacturing process of an absorption electrode according to an embodiment of the inventive concept.

FIG. 2A is an exemplary diagram illustrating producing a reduced graphene oxide during a manufacturing process of an absorption electrode according to an embodiment of the inventive concept. In addition, FIG. 2B is an exemplary diagram illustrating producing a composite during a manufacturing process of an absorption electrode according to an embodiment of the inventive concept.

FIG. 3 shows an XRD of a composite of an absorption electrode according to an embodiment of the inventive concept.

FIG. 4 is SEM images of a layered double hydroxide (LDH) and a composite according to an embodiment of the inventive concept.

FIG. 5 is TEM images of a typical layered double hydroxide and a composite according to an embodiment of the inventive concept.

FIG. 6 is an exemplary diagram showing a typical structure of a layered double hydroxide.

FIG. 7 is a flow chart schematically illustrating a water treatment process using an absorption electrode according to an embodiment of the inventive concept.

FIG. 8 is an exemplary diagram illustrating an absorption process using an absorption electrode according to an embodiment of the inventive concept.

FIG. 9 is exemplary diagrams illustrating ligand exchange occurring on a surface of an absorption electrode according to an embodiment of the inventive concept.

FIG. 10 is exemplary diagrams illustrating ion exchange between layered double hydroxides of an absorption electrode according to an embodiment of the inventive concept.

FIG. 11 is a graph showing removal rates of phosphorus ion and chlorine ion using an absorption electrode according to an embodiment of the inventive concept.

FIG. 12 is a graph showing, during an absorption process using an absorption electrode according to an embodiment of the inventive concept, potential change of the electrode.

FIG. 13 is an exemplary diagram illustrating a recycling process using an absorption electrode according to an embodiment of the inventive concept.

FIG. 14 is a graph showing, during a recycling process using an absorption electrode according to an embodiment of the inventive concept, a potential change of the electrode.

FIG. 15 is graphs showing capacity changes in a cycle of absorption and recycling processes according to an embodiment of the inventive concept.

FIGS. 16A and 16B are graphs comparing recycling capacities of an absorption electrode according to an embodiment of the inventive concept depending on recycling solution changes.

### DETAILED DESCRIPTION

Hereinafter, the inventive concept will be described in detail with reference to the drawings attached to the inventive concept. First, it should be noted that, in the drawings, the same components or parts have the same reference numerals as much as possible. In the following description of the inventive concept, well-known functions or constructions are not described in detail in order to avoid obscuring the inventive concept in unnecessary detail.

As used herein, the term “substantially,” “about,” and similar terms are used as terms of approximation and not as terms of degree, and are intended to account for the inherent deviations in measured or calculated values that would be recognized by those of ordinary skill in the art. The term “substantially,” “about,” and similar terms may be recited for understanding of the inventive concept or may not be intended to exactly limit the inventive concept to a recited numerical value to prevent an intentional infringer from designing around the inventive concept.

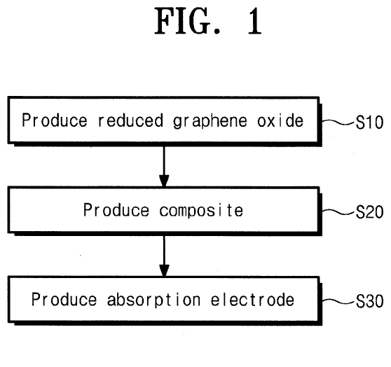

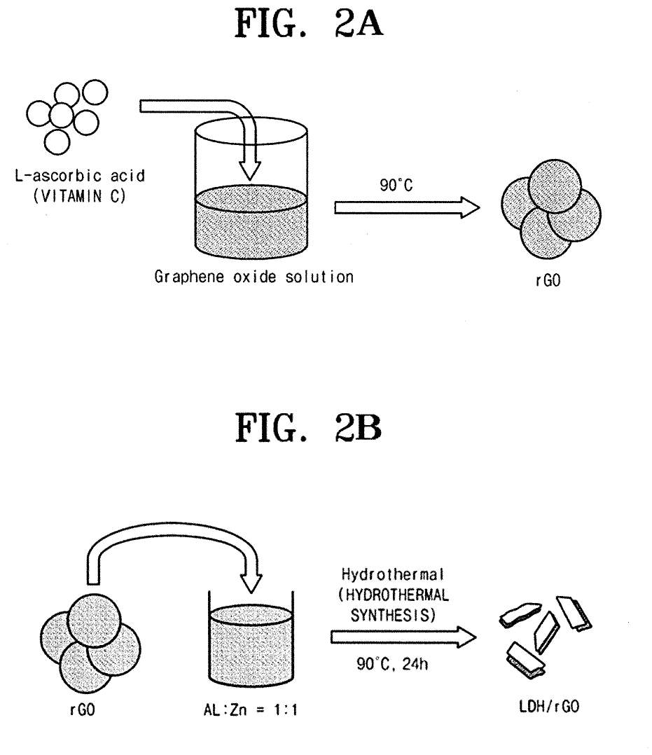

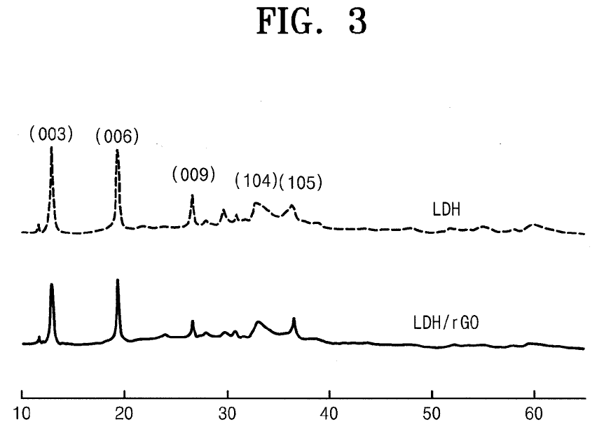

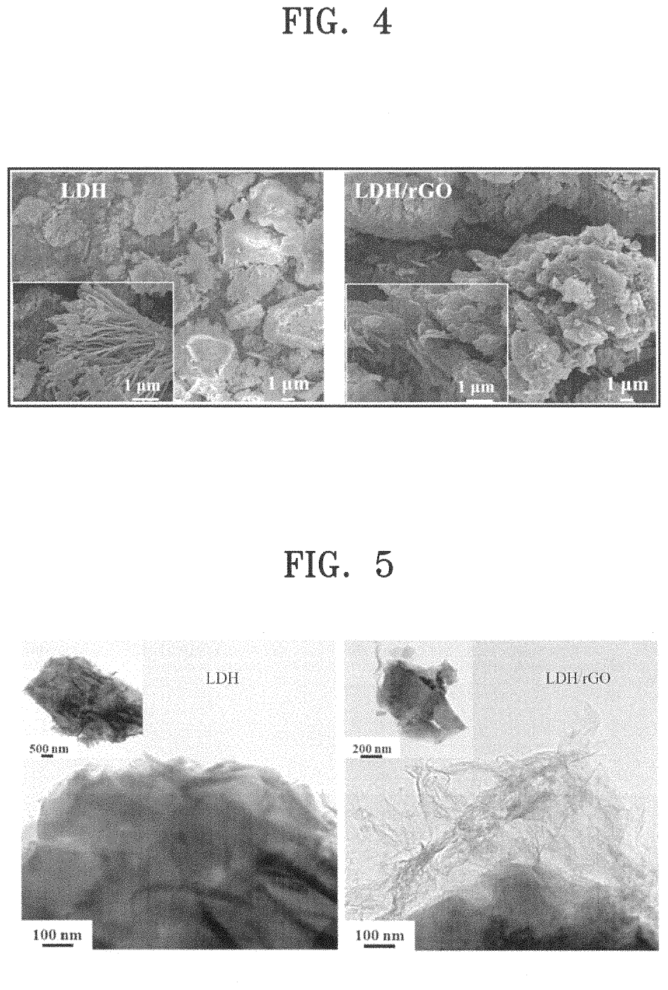

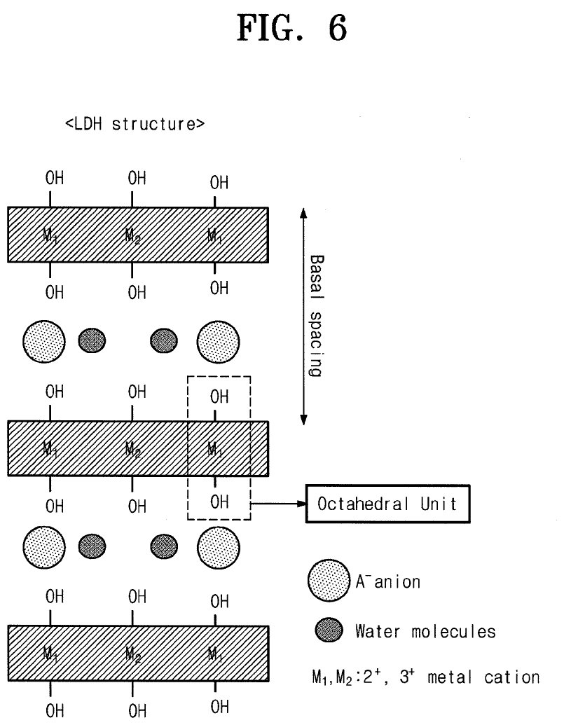

FIG. 1 is a flow chart schematically showing a manufacturing process of an absorption electrode according to an embodiment of the inventive concept. FIG. 2A is an exemplary diagram illustrating producing a reduced graphene oxide during a manufacturing process of an absorption electrode according to an embodiment of the inventive concept. FIG. 2B is an exemplary diagram illustrating producing a composite during a manufacturing process of an absorption electrode according to an embodiment of the inventive concept. FIG. 3 shows an XRD of a composite of an absorption electrode according to an embodiment of the inventive concept. FIG. 4 is SEM images of a layered double hydroxide (LDH) and a composite according to an embodiment of the inventive concept. FIG. 5 is TEM images of a typical layered double hydroxide and a composite according to an embodiment of the inventive concept. FIG. 6 is an exemplary diagram showing a typical structure of a layered double hydroxide.

An absorption electrode manufacturing process according to the inventive concept is to manufacture an absorption electrode containing a composite of a reduced graphene oxide (rGO) and a layered double hydroxide (LDH). With reference to FIG. 1, the absorption electrode manufacturing process includes producing a reduced graphene oxide (S10), producing a composite (S20), and obtaining an absorption electrode (S30).

In one example, phosphorus contaminants may be efficiently removed from the water used for drinking water, and the like, and the used absorption electrode may be recycled quickly and eco-friendly by the absorption electrode manufactured by the absorption electrode manufacturing process according to the inventive concept. Further, pentavalent arsenic contaminants with a very similar chemical property to the phosphorus may be efficiently removed by the absorption electrode manufactured by the absorption electrode manufacturing process according to the inventive concept.

Herein, it is preferable that the contaminants present as trivalent arsenic are converted to pentavalent arsenic via a pretreatment, and then removed using the absorption electrode according to the inventive concept.

Herein, as a method for converting trivalent arsenic to pentavalent arsenic by oxidizing it, chemical and electrical methods exist, but the inventive concept is not limited thereto.

With reference to FIG. 2A, in producing the reduced graphene oxide (S10), a reducing agent is added to the graphene oxide solution to produce a reduced graphene oxide (rGO).

Herein, the graphene oxide may include, but is not limited to, a structure in which a functional group containing oxygen such as a carboxyl group, a hydroxyl group, or an epoxy group, and the like is bonded on a single layer graphene.

In addition, the reduced graphene oxide may mean a graphene oxide with reduced oxygen ratio after a reduction process.

The reducing agent may be selected from a group consisting of hydrazine solution, sodium borohydride, ascorbic acid, phenylhydrazine iodide, and a mixture thereof.

In an embodiment of the inventive concept, L-ascorbic acid was selected as the reducing agent.

With reference to FIG. 2B, in producing the composite (S20), the reduced graphene oxide produced in the previous phase (S10) is added to solution in which a divalent metal and a trivalent metal are dispersed therein to produce a mixture, and the mixture is hydrothermally synthesized to obtain a composite containing a reduced graphene oxide and a layered double hydroxide.

Herein, the divalent metal may be at least one selected from a group consisting of Zn²⁺, Mn²⁺, Ni²⁺, Co²⁺, Fe²⁺, Cu²⁺, Sn²⁺, Ba²⁺, Ca²⁺, and Mg²⁺. In addition, the trivalent metal may be at least one selected from a group consisting of Al³⁺, Cr³⁺, Fe³⁺, Co³⁺, Mn³⁺, Ni³⁺, Ce³⁺, and Ga³⁺.

In an embodiment of the inventive concept, Zn2+ was selected as the divalent metal, and Al³⁺ was selected as the trivalent metal.

Herein, the divalent metal and the trivalent metal may be dispersed in the solution at a ratio of 1:1.

With reference to FIG. 3, it may be seen that XRD patterns of a typical layered double hydroxide (LDH) and the composite (LDH/rGO) manufactured by the method of the inventive concept are very similar. Further, it may be confirmed that the composite obtained in producing the composite (S20) was synthesized to have structural characteristics of the layered double hydroxide.

Further, with reference to FIG. 4 and FIG. 5, it may be seen that, in the composite, the reduced graphene oxide (rGO) was precisely synthesized on an outer face of the layered double hydroxide.

With reference to FIG. 6, a typical layered double hydroxide (LDH) may have a structure similar to that of hydrotalcite having a layered double hydroxide structure of a divalent metal (for example, zinc) and a trivalent metal (for example, aluminum).

The layered double hydroxide is able to introduce various anions between layers because the layer itself is positively charged due to the presence of the trivalent metal ions in the layer.

However, since such layered double hydroxide is composed of inorganic substances, it is difficult to use it as a conductor.

Thereafter, in obtaining the absorption electrode (S30), the composite of the reduced graphene oxide and the layered double hydroxide produced in the previous step (S20) may be mixed with a conductor and a binder, thereby producing a sheet-type electrode.

The conductor may include carbon black.

Herein, the composite, the conductor, and the binder may be mixed at a ratio of 10:1:1 to 5:1:1. In one example, preferably the composite, the conductor, and the binder may be mixed at a ratio of 8:1:1.

Hereinafter, with reference to FIG. 2A and FIG. 2B, an example of the inventive concept will be described in detail.

### EXAMPLE 1

Solution in which graphene oxide was dissolved at 5 mg/L was prepared. In addition, L-ascorbic acid 30 g/L was prepared as the reducing agent. Then, the L-ascorbic acid is added to the graphene oxide solution, and reacted at 90° C., thereby obtaining a reduced graphene oxide (rGO) (S10).

Thereafter, the rGO thus obtained was mixed with zinc and aluminum at a ratio of 1:1, then was dissolved in 250 ml of solution dispersed at a concentration of 0.5 mg/ml.

Here, the zinc was prepared as 0.744 g of Zn(NO₃)₂.6H₂O powder, and the aluminum was prepared as 0.479 g of Al(NO₃)₃.9H₂O powder. In addition, 0.526 g of urea may be prepared as an additive.

Thereafter, the solution containing rGO was hydrothermally synthesized at 95 ° C. for 24 hours to obtain a composite containing a layered double hydroxide and a reduced graphene oxide (LDH/rGO).

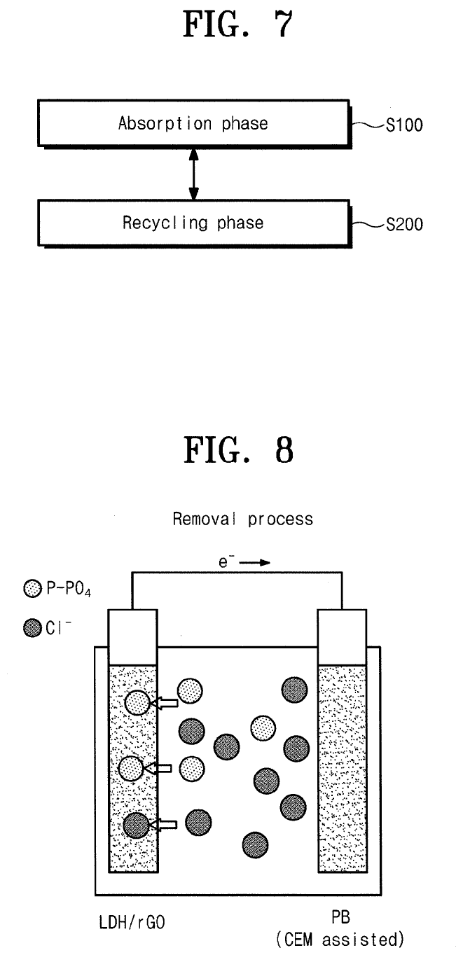

Hereinafter, with reference to FIG. 7 to FIG. 16B, a water treatment process using the absorption electrode manufactured in Example 1 will be described.

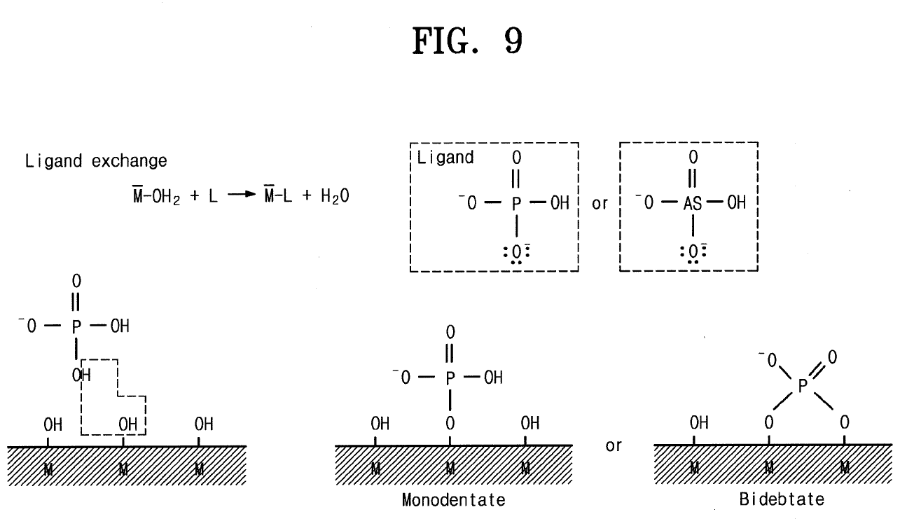

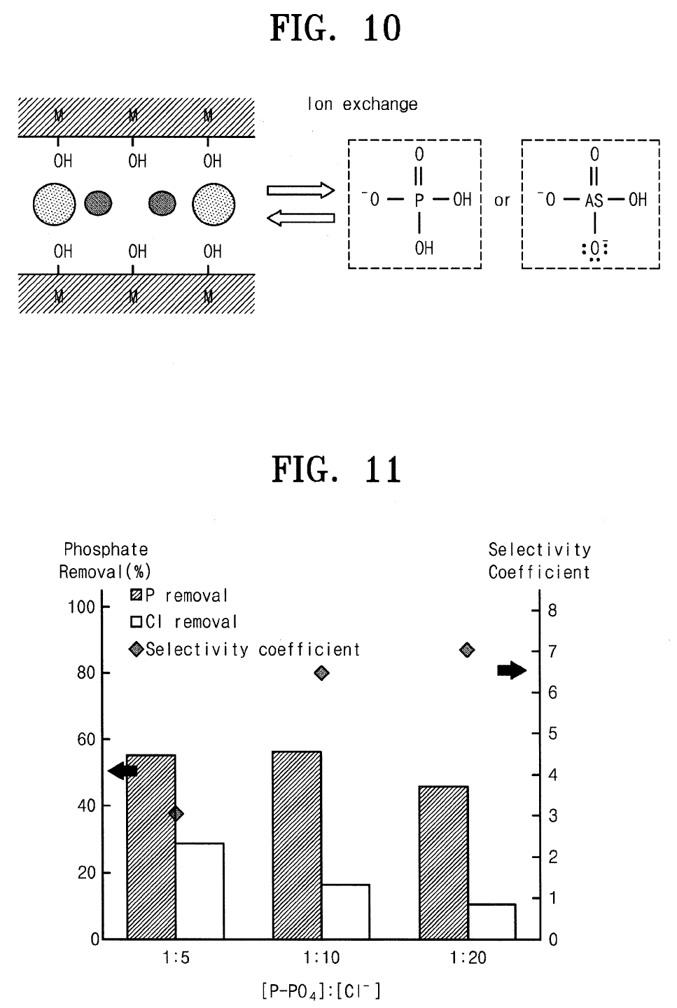

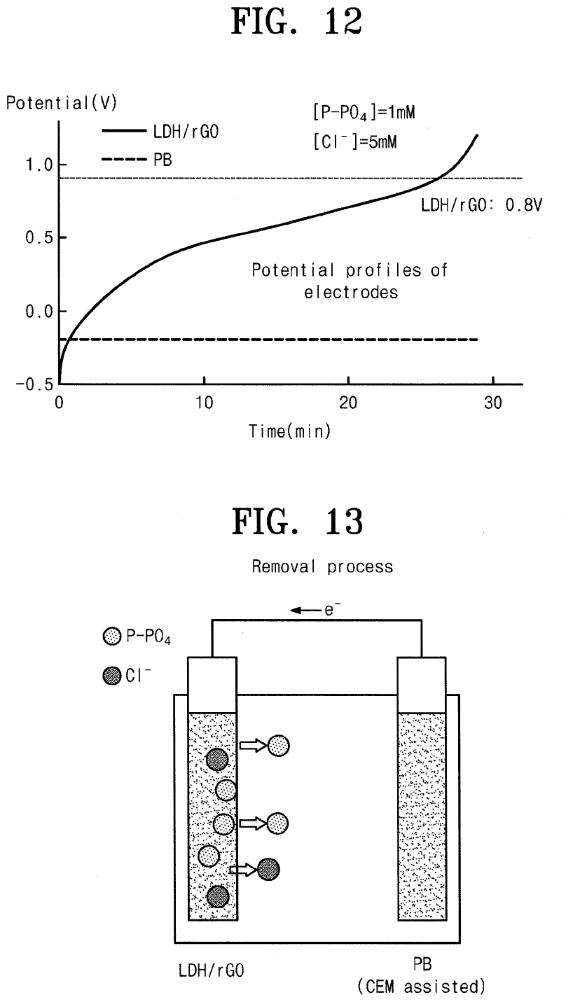

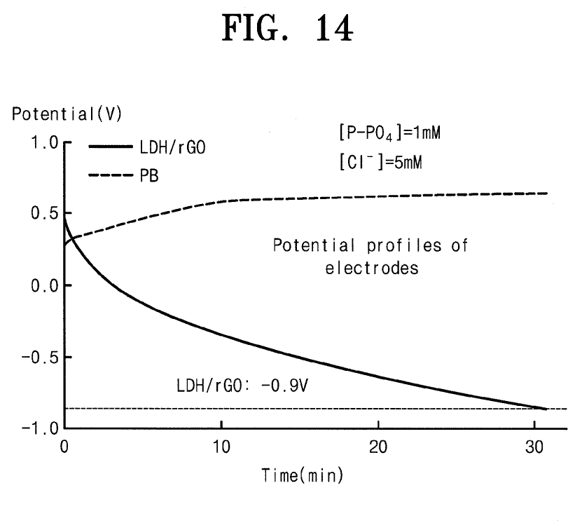

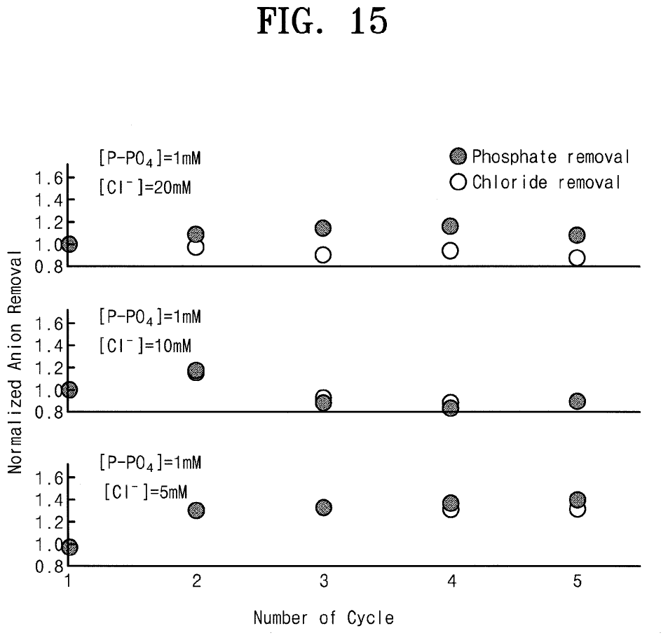

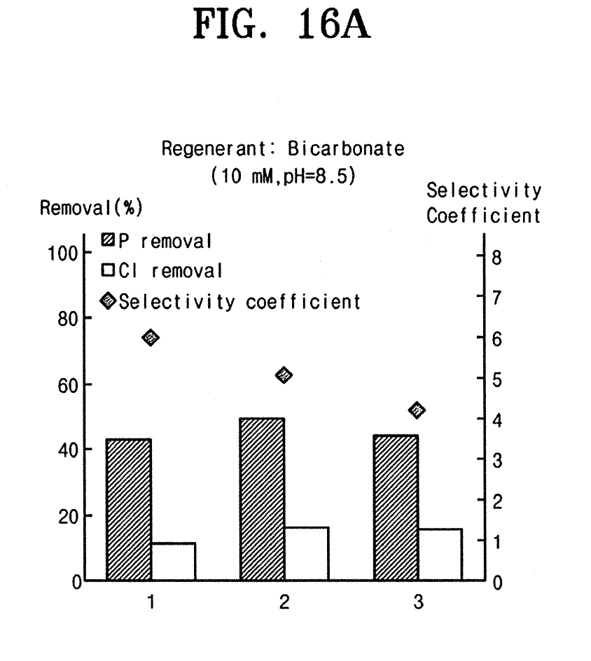

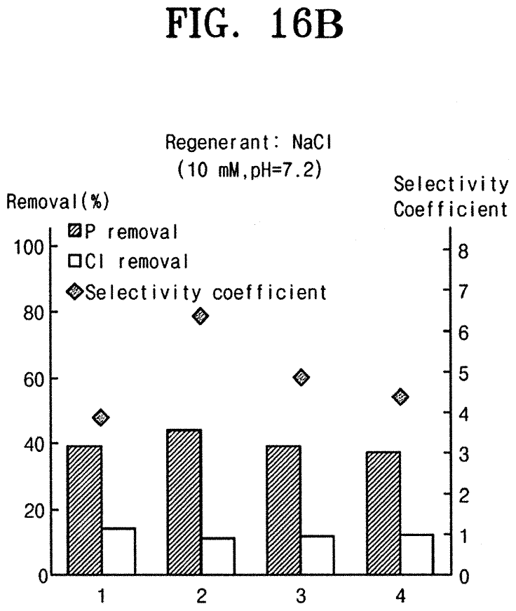

FIG. 7 is a flow chart schematically illustrating a water treatment process using an absorption electrode according to an embodiment of the inventive concept. FIG. 8 is an exemplary diagram illustrating an absorption process using an absorption electrode according to an embodiment of the inventive concept. FIG. 9 is exemplary diagrams illustrating ligand exchange occurring on a surface of an absorption electrode according to an embodiment of the inventive concept. FIG. 10 is exemplary diagrams illustrating ion exchange between layered double hydroxides of an absorption electrode according to an embodiment of the inventive concept. FIG. 11 is a graph showing removal rates of phosphorus ion and chlorine ion using an absorption electrode according to an embodiment of the inventive concept. FIG. 12 is a graph showing, during an absorption process using an absorption electrode according to an embodiment of the inventive concept, a potential change of the electrode. FIG. 13 is an exemplary diagram illustrating a recycling process using an absorption electrode according to an embodiment of the inventive concept. FIG. 14 is a graph showing, during a recycling process using an absorption electrode according to an embodiment of the inventive concept, a potential change of the electrode. FIG. 15 is graphs showing capacity changes in a cycle of absorption and recycling processes according to an embodiment of the inventive concept. FIGS. 16A and 16B are graphs comparing recycling capacities of an absorption electrode according to an embodiment of the inventive concept depending on recycling solution changes.

A water treatment process using an absorption electrode according to an embodiment of the inventive concept includes an absorption phase (S100), and a recycling phase (S200).

In the absorption phase (S100), a semi batch process was used, and the technique was applied to a mixed solution of a neutral (pH-7) chlorine (Cl) anion and phosphate. In the absorption phase (S100), a current density was 0.6 mA/cm². Further, Prussian blue analogue was used as an electrode for removing a cation, and an absorption electrode (LDH/rGO) manufactured by the inventive concept was used as an electrode for removing an anion.

Here, the electrode for removing the cation does not affect the inventive concept, so that it is easily replaceable by those skilled in the art.

With reference to FIG. 8, when positive voltage is applied to the absorption electrode side, an anion in wastewater is attracted to the absorption electrode side. Thereafter, the anion adjacent to the absorption electrode side may be absorbed into a layered double hydroxide of the absorption electrode.

Here, the layered double hydroxide has a space between a plurality of plate-like structures.

Therethrough, as shown in FIG. 9, the anion may absorb a phosphorus ion or a pentavalent arsenic ion on a surface of the plate-like structure through a ligand exchange. Further, as shown in FIG. 10, the anion may absorb the phosphorus ion or the pentavalent arsenic ion selectively through an ion exchange manner by being inserted into the space between the plate-like structures.

Here, since an electronegativity of the phosphorus and the arsenic is very similar (2.18, 2.19), in the absorption electrode of the present inventive concept, a binding of As—O-M is preferred as much as a binding of P-O-M in the ligand exchange. Thus, an absorption selectivity to a certain ion is caused.

That is, the absorption electrode manufactured by the inventive concept has excellent absorption selectivity to the phosphorus ion or the pentavalent arsenic ion.

For example, as shown in FIG. 11, even when the phosphorus and the chlorine are present in various concentrations in the wastewater requiring treatment, it may be seen that the absorption electrode manufactured by the inventive concept has a higher ion selectivity coefficient to the phosphate than to the chlorine.

In particular, in the absorption electrode manufactured by the inventive concept, an ion selectivity coefficient to the phosphate may be calculated from 3 to 7. Even though a concentration of the chlorine ion is about 20 times higher than a concentration of the phosphorus ion, it may be seen that the absorption electrode manufactured by the inventive concept may realize a removal capacity of about 7 times for the phosphorus ion than the chlorine ion.

That is, it may be seen that the absorption electrode manufactured by the inventive concept has high selectivity to the phosphorus ion, and the phosphate ion.

Here, the ion selection coefficient may be defined by a following Equation 1.

$$Selectivity coefficient = \frac{{a}_{A} / {c}_{A}}{{a}_{B} / {c}_{B}} \\ {a}_{A or B} \text{:} Adsorbed concentration of A or B ion \\ {c}_{A or B} \text{:} Bulk concentration of A or B ion \qquad [ Equation 1 ]$$

A voltage change per time in the absorption phase (S100) is shown in FIG. 12. A voltage, as a process variable, applied to the absorption electrode manufactured by the inventive concept preferably do not exceed a maximum of 0.8 V to prevent water from decomposing.

Thereafter, in the recycling phase (S200), a semi batch process was used, a current density was 0.6 mA/cm², and a rest configuration of an electrochemical system was made in the same manner as in the absorption phase (S100).

In the recycling phase (S200), with reference to FIG. 13, when negative voltage is applied to the absorption electrode side, the anion absorbed in the layered double hydroxide of the absorption electrode is desorbed to the recycling solution, thereby recycling the absorption electrode.

Thereafter, immersing an anion exchange resin in (NH₄)₆Mo₇O₂₄ solution for 4 hours, a Mo₇O₂₄⁶⁻ ion in the solution may enter the anion exchange resin.

Here, when a non-electrochemical method is used to recycle previously used absorbent (LDH) using a recycling solution (NaOH), it takes at least 6 hours and at most one day. In this process, 100 to 1000 mM of NaOH is consumed.

On the other hand, using the electrical method using the absorption electrode manufactured by the inventive concept, even though only 10 mM of NaOH is used, the recycling of the electrode is completed in 40 minutes, so that more effective and quick treatment may be completed than the conventional method. In addition, this reduces the amount of NaOH consumed, which is economical and may also help solve environmental problems.

A voltage change per time in the recycling phase (S200) is shown in FIG. 14. A voltage, as a process variable, applied to the absorption electrode manufactured by the inventive concept preferably do not exceed a maximum of −0.9 V to prevent water from decomposing.

Further, with reference to FIG. 15, the anion removal capacity of the absorption electrode manufactured by the inventive concept manufactured by the inventive concept is maintained similar in each repeated cycle of the absorption/recycling phase. Thus, it may be seen that a reliability of the absorption electrode is secured.

Further, with reference to FIGS. 16A and 16B, it may be seen that, even though the recycling solution changes, the absorption electrode manufactured by the inventive concept has high selectivity for removing the phosphorus ion, and the anion removal capacity remains. That is, more environmentally friendly recycling solution may be used, which may result in eco-friendly and economical effects.

In accordance with the inventive concept, the method for manufacturing the absorption electrode, and the absorption electrode manufactured using the method may efficiently remove contaminants such as phosphorus, or pentavalent arsenic from water used as drinking water, and the like, and may recycle the used absorption electrode quickly and environmentally.

The absorption electrode according to the inventive concept capable of absorbing a trace amount of phosphorus, or pentavalent arsenic dissolved in water, and of having a high absorption efficiency based on a selectivity may be manufactured.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for manufacturing an absorption electrode, the method comprising:
producing a reduced graphene oxide;
producing a composite containing the reduced graphene oxide, and a layered double hydroxide; and
producing the absorption electrode containing the composite.

2. The method of claim 1, wherein the producing of the absorption electrode includes mixing the composite, a conductor, and a binder to produce the absorption electrode.

3. The method of claim 2, wherein the producing of the absorption electrode includes mixing the composite, the conductor, and the binder ata ratio of 10:1:1 to 5:1:1.

4. The method of claim 1, wherein the producing of the reduced graphene oxide includes adding a reducing agent to graphene oxide solution to reduce the graphene oxide, and
wherein the reducing agent is selected from a group consisting of hydrazine solution, sodium borohydride, ascorbic acid, phenylhydrazine iodide, and a mixture thereof.

5. The method of claim 1, wherein in producing the composite, the layered double hydroxide contains a divalent metal and a trivalent metal, and
wherein the divalent metal is at least one selected from a group consisting of Zn²⁺, mn²⁺, Ni²⁺, Co²⁺, Fe²⁺, Sn²⁺, Ba²⁺, Ca²⁺, and Mg²⁺, and
wherein the trivalent metal is at least one selected from a group consisting of Al³⁺, Cr³⁺, Fe³⁺, Co³⁺, Mn³⁺, Ni³⁺, Ce³⁺, and Ga³⁺.

6. The method of claim 5, wherein the producing of the composite includes:
adding the reduced graphene oxide to a solution containing the dispersed divalent metal and trivalent metal to produce a mixture; and
hydrothermally-synthesizing the mixture to obtain the composite containing the reduced graphene oxide and the layered double hydroxide.

7. An absorption electrode comprising a composite, wherein the composite contains a reduced graphene oxide and a layered double hydroxide.

8. The absorption electrode of claim 7, further comprising a conductor, and a binder, and
wherein the composite, the conductor, and the binder are mixed at a ratio of 10:1:1 to 5:1:1.

9. The absorption electrode of claim 7, wherein an ion selectivity coefficient of the absorption electrode to a first ion is larger than an ion selectivity coefficient of the absorption electrode to a second ion different from the first ion,
wherein the first ion includes a phosphorus (P) ion, and a pentavalent arsenic (As⁺⁵) ion.

10. The absorption electrode of claim 9, wherein the second ion includes a chlorine (Cl) ion.

11. The absorption electrode of claim 9, wherein when a concentration of the second ion is 5 to 20 times a concentration of the first ion,
an absorption capacity of the absorption electrode with respect to the first ion is 3 to 7 times an absorption capacity of the absorption electrode with respect to the second ion.

12. The absorption electrode of claim 7, wherein the layered double hydroxide includes a divalent metal and a trivalent metal, and
wherein the divalent metal is at least one selected from a group consisting of Zn²⁺, Mn²⁺, Ni²⁺, Co²⁺, Fe²⁺, Sn²⁺, Ba²⁺, Ca²⁺, and Mg²⁺, and
wherein the trivalent metal is at least one selected from a group consisting of Al³⁺, Cr³⁺, Fe³⁺, Co³⁺, Mn³⁺, Ni³⁺, Ce³⁺, and Ga³⁺.
